(19) United States
(12) Patent Application Publication
(10) Pub. No.: US 2005/0003296 A1
(43) Pub. Date: Jan. 6, 2005

(54) Development enhancement of radiation-sensitive elements

(76) Inventors: Livia T. Memetea, Coquitlam (CA); Juana G. Jaramillo, Coquitlam (CA); Nicholas Bradford, Richmond (CA); Jonathan W. Goodin, Tyler, TX (US); Cheng Yang, Burnaby (CA); Moshe Levanon, Kfar Aharon (IL)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/800,133

(22) Filed: Mar. 12, 2004

Related U.S. Application Data
(63) Continuation-in-part of application No. 10/647,910, filed on Aug. 25, 2003, now abandoned.
(63) Continuation-in-part of application No. 10/388,488, filed on Mar. 17, 2003.
(60) Provisional application No. 60/364,078, filed on Mar. 15, 2002.

(51) Int. Cl. G03C 1/76

(52) U.S. Cl. 430/270.1

(57) ABSTRACT

A positive-working radiation-sensitive composition for use with a radiation source comprises one or more polivinyl acetal polymers capable of being dissolved in an alkaline aqueous solution and a development-enhancing compound. The sensitivity of a radiation-sensitive coating based on the composition of this invention is increased without compromising the handling characteristics. Radiation-sensitive elements based on the composition of the invention have good development latitude. A positive-working lithographic printing precursor is based on the radiation-sensitive composition coated on a hydrophilic surface. The precursor is developable using an alkaline aqueous solution, and may be used with a radiation source in lithographic applications, such as conventional imaging systems, computer-to-plate systems or other direct imaging applications. The precursor is stable in its state before exposure and has an excellent handling property.

### CROSS-REFERENCE TO RELATED APPLICATIONS

This application is a continuation-in-part of U.S. application Ser. No. 10/647,910, filed Aug. 25, 2003, and is a continuation-in-part of U.S. application Ser. No. 10/388,488, filed Mar. 17, 2003, and claims the benefit of U.S. provisional application No. 60/364,078, filed Mar. 15, 2002.

### FIELD OF THE INVENTION

The invention pertains to the field of radiation-sensitive compositions and, in particular, to their use in imaging elements.

### BACKGROUND OF THE INVENTION

Lithographic processes involve establishing image (printing) and non-image (non-printing) areas on a substrate, substantially on a common plane. When such processes are used in printing industries, non-image areas and image areas are arranged to have different affinities for printing ink. For example, non-image areas may be generally hydrophilic or oleophobic and image areas may be oleophilic.

Certain types of electronic parts may be manufactured using lithographic manufacturing technology. The types of electronic parts whose manufacture may use a radiation-sensitive composition include printed wiring circuit boards, thick- and thin-film circuits, comprising passive elements such as resistors, capacitors and inductors; multichip devices; integrated circuits; and active semiconductor devices. The electronic parts may suitably comprise conductors, for example copper board; semiconductors and insulators, for example silica, as a surface layer with silicon beneath, with the silica being selectively etched away to expose portions of the silicon beneath. In relation to masks, a required pattern may be formed in the coating on the mask precursor, for example a plastic film, which is then used in a later processing step, in forming a pattern on, for example, a printing or electronic part substrate.

Conventionally, laser direct imaging methods (LDI) have been known which directly form an offset printing plate or printed circuit board on the basis of digital data from a computer. LDI offers the potential benefits of better line quality, just-in-time processing, improved manufacturing yields, elimination of film costs, and other recognized advantages. There has been remarkable development in the area of lasers. In particular, solid state lasers and semiconductor lasers having a luminous band from near infrared wavelengths to infrared wavelengths and which are small-sized and have a high energy output have become commercially available. These lasers are very useful as exposure light sources for exposure when LDI is required. Thermally sensitive imaging elements are classified as compositions that undergo chemical transformation(s) in response to exposure to, and absorption of, suitable amounts of heat energy. The nature of thermally induced chemical transformation may be to ablate the composition, or to change the solubility of the composition in a particular developer, or to change tackiness of the surface, or to change the hydrophilicity or the hydrophobicity of the surface of the thermally sensitive layer. As such, selective heat exposure of predetermined areas (imagewise distribution of heat energy) of a thermally sensitive film or layer has the capability of directly or indirectly producing a suitably imaged film or layer which can serve as a resist pattern in printed circuit board fabrication, or in production of lithographic printing plates. Positive working systems based on novolak-diazoquinone resins are an imaging mainstay of the computer chip industry (see, e.g. R. R. Dammel, “Diazonaphthoquinone-based Resists”, Tutorial text No. 11, SPIE Press, Bellingham. Wash., 993).

Compositions of light sensitive novolak-diazoquinone resins are also widely used in the printing plate fabrication. The light sensitive diazonaphthoquinone derivatives (DNQ) added to novolak resins (a phenol-formaldehyde condensation polymer) slows down the dissolution of the resin. A revised molecular mechanism of novolak-DNQ imaging materials has been suggested (A. Reiser, Journal of Imaging Science and Technology, Volume 42, Number 1, January/February 1998, pp. 15-22). This text teaches that the basic features of the imaging phenomena in novolak-diazonaphthoquinone compositions is the observed inhibition of dissolution of the resin, based on the formation of phenolic strings by the interaction of the strong hydrogen acceptor which acts as a solubility inhibitor with the OH groups of the resin. On exposure, the hydrogen bonding between the phenolic strings is severed during a reaction known as the Wolff rearrangement, which follows photolysis of the diazoquinone moiety of the inhibitor molecule. This rearrangement is not only very fast, but also highly exothermic. (ΔH° is at least −66 kcal/mol). The sudden appearance at the location of the solubility inhibitor of a heat pulse of that magnitude, causes a major temperature spike of not less than about 220° C. At the high temperature that is produced at the location of the solubility inhibitor, the phenolic string is severed from its anchor at the DNQ and becomes inactive (dispersed). This happens because it is no longer held together by the inductive effect of the solubility inhibitor. Positive-working direct laser addressable printing form precursors based on phenolic resins sensitive to UV, visible and/or infrared radiation have been described. See, for example, U.S. Pat. No. 4,708,925, U.S. Pat. No. 5,372,907 and U.S. Pat. No. 5,491,046.

In U.S. Pat. No. 4,708,925, the phenolic resin dissolution in alkaline solution is decreased by a radiation-sensitive onium salt, such as triphenylsulfoniumhexafluoro-phosphate, instead of DNQ, with the native solubility of the resin being restored upon photolytic decomposition of the onium salt. The onium salt composition is intrinsically sensitive to UV radiation and can be additionally sensitized to infrared radiation. In U.S. Pat. No. 6,037,085 and U.S. Pat. No. 5,962,192 thermal laser-sensitive compositions are described based on azide-materials wherein a dye-component is added to obtain the requisite sensitivity.

A wide range of thermally-induced compositions, useful as thermographic recording materials, are disclosed in patent GB 1,245,924, whereby the solubility of any given area of the imageable layer in a given solvent can be increased by the heating of the layer by indirect exposure to a short duration high intensity visible light and/or infrared radiation transmitted or reflected from the background areas of a graphic original located in contact with the recording material. Several systems are described which operate by many different mechanisms and use different developing materials ranging from water to chlorinated organic solvents. Included in the range of aqueous developable compositions disclosed, are those that comprise a novolak type phenolic resin. The patent describes coated films of such resins that show increased solubility on heating. The compositions may contain heat-absorbing compounds such as carbon black or Milori Blue (C.I. Pigment Blue 27); these materials additionally color the images for their use as a recording medium.

Other compositions that include dissolution-inhibiting materials are described in the patent literature. Examples include WO 97/39894, WO 98/42507, WO99/08879, WO99/01795, WO99/21725, U.S. Pat. No. 6,117,623, U.S. Pat. No. 6,124,425, EP 940266 and WO 99/11458. However, the infrared dye, or the like mainly functions as a radiation absorber and provides a minimal binder dissolution function in exposed areas.

In U.S. Pat. No. 5,840,467 Kitatani et al describe a positive working image recording material, which comprises a binder, a light-to-heat converter substance capable of generating heat by the absorption of infrared rays or near infrared rays, and a heat-decomposable substance capable of substantially lowering the solubility of the material when the substance is in the undecomposed state. Specific examples of the heat-decomposable substance include diazonium salts and quinonediazides. Specific examples of the binder include phenolic, acrylic and polyurethane resins. Various pigments and dyes are given as potential light-to-heat converter substances, including specifically cyanine dyes. The image recording material may be coated onto suitable substrates to create an imageable element. Elements so created may be imagewise irradiated with laser light and the irradiated areas removed with an alkaline developer.

Several materials capable of increasing the sensitivity of positive-working compositions have been described. Cyclic anhydrides as sensitizers are described in U.S. Pat. No. 4,115,128; examples include phthalic anhydride, succinic anhydride and pyromellitic anhydride. Phenols and organic acids have also been described in JP-A Nos. 60-88942 and 2-96755. Specific examples include bisphenol A, 2,3,4-trihydroxybenzophenone, 4-hydroxybenzophenone, p-toluenesulfonic acid, dodecylbenzenesulfonic acid, phenyl phosphate, diphenyl phosphate, benzoic acid, isophthalic acid, adipic acid, terephthalic acid, lauric acid, and ascorbic acid or the like.

### SUMMARY OF THE INVENTION

A positive radiation-sensitive composition for use with a radiation source comprises one or more polymers capable of being dissolved in an aqueous alkaline solution and a developability-enhancing compound. The invention provides a positive-working radiation-sensitive composition of good sensitivity for use with a radiation source in lithographic applications, such as conventional imaging systems, computer-to-plate systems or other direct imaging elements and applications. The composition is stable in its state before exposure and has excellent handling properties.

According to a first broad aspect of the invention, there is provided a radiation-sensitive composition comprising at least one aqueous alkali-soluble polymer and a developability-enhancing compound. It is preferred to include a radiation-to-heat compound in the composition to match the sensitivity range of the composition to the wavelength of the radiation source.

According to a second broad aspect of the invention, there is provided a positive-working imageable element comprising, on a substrate, a coating, the coating comprising the composition as aforesaid. The imageable element is imageable by radiation, preferably infrared radiation, and is developable using an alkaline aqueous developer solution.

According to the invention, there is also provided a positive-working lithographic printing precursor comprising, on a hydrophilic lithographic base with a hydrophilic lithographic printing surface, a coating, the coating comprising the composition as aforesaid. The precursor is imageable by radiation, preferably infrared radiation, and is developable using an alkaline aqueous developer solution. In a further aspect of the invention, there is provided a positive-working lithographic printing master comprising a precursor as aforesaid, imaged and developed. As further aspects of the invention, there are provided methods for the preparation of the precursor and the master.

### DETAILED DESCRIPTION OF THE PREFERRED EMBODIMENT

The inventors have studied positive-working radiation-sensitive compositions, and have found that specific combinations of an alkali aqueous solution soluble polymer compound and certain developability-enhancing compounds, allow the fabrication of positive-working lithographic printing precursors that require less total illuminating energy to produce a desired level of developability, as compared with when the developability-enhancing compound is not present.

According to the present invention, a positive radiation-sensitive composition for use with a radiation source comprises, as polymer component (A), one or more polymer compounds capable of being dissolved in an alkali aqueous solution, and a component (B), referred to herein as a developability-enhancing compound(B).

The polymer component (A) has some degree of solubility in alkaline aqueous solution, though preferably a low degree. In a radiation-sensitive layer formed from the compositions of the invention, the polymer has low solubility due either to its inherently low solubility, or due to interactions of moieties within its own molecules or interaction with other materials in the composition, for example based on hydrogen bonding or the like.

The positive-working radiation-sensitive composition of the present invention may be coated on a substrate and dried to form a radiation-sensitive imageable layer, thereby creating an imageable element. In a preferred embodiment of the present invention, the positive-working radiation-sensitive composition is coated onto a hydrophilic lithographic base and dried, thereby to form a positive-working lithographic printing precursor. When the imageable layer is illuminated, it becomes more soluble in alkaline aqueous solution. By addition of a developability-enhancing compound (B), described in more detail below, the energy needed in exposing the composition to obtain a desired level of developability, is decreased, as compared with a coating that does not contain developability-enhancing compound (B). Areas of the coating that are not exposed to the radiation (and are therefore not heated through the absorption and conversion of the radiation to heat) do not exhibit significant change in the rate of dissolution in developer. While the addition of developability-enhancing compound (B) may in fact to some degree increase the solubility of the coated and dried composition in alkaline aqueous solution, the increase in solubility of the coated and dried composition when illuminated is much enhanced. This provides an improved developability of the image that is formed by the radiation. The solubility in the irradiated areas does not restore to its pre-illumination value after any amount of time subsequent to such illumination.

It is to be understood that an increase in the rate of dissolution of the coating means, for purposes of the invention, an increase that is an amount useful in the image-forming process. It does not include any increase that is less than a useful amount in the image-forming process. The invention provides a positive photosensitive composition for use with a radiation source in lithographic applications, such as conventional imaging systems, computer-to-plate systems or other direct imaging elements and applications. It is stable in its state before exposure and has excellent handling properties.

U.S. Pat. No. 6,255,033 to Levanon et al. describes a polyvinyl acetal polymer having phenolic groups, and also describes its synthesis by the grafting or condensation of aldehydes onto polyvinyl alcohol by acetalization. This polyvinyl acetal polymer can be used in the present invention, either alone, or in combination with other resins, as polymer component(A) of the present invention. The specification of U.S. Pat. No. 6,255,033 is hereby incorporated in full. The general structure of the polymer is given by the formula: 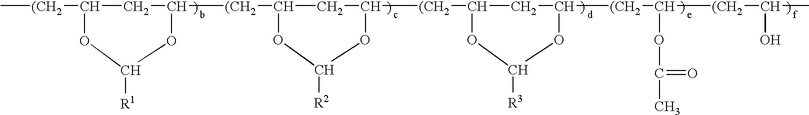
in which R¹ is —CₙH₂ₙ₊₁ where n=1 to 12, and R² is 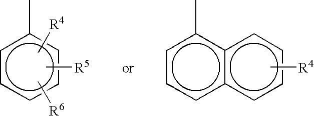
wherein R⁴=—OH;
R⁵═—OH or —OCH₃ or Br— or —O—CH₂—C≡CH and
R⁶═Br— or NO₂
R³═—(CH₂)ₜ—COOH, —C≡CH, or
where R⁷═COOH, —(CH₂)ₜ—COOH, —O—(CH₂)ₜ—COOH, 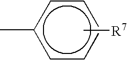
and in which t=1 to 4, and where
b=5 to 40 mole %, preferably 15 to 35 mole %
c=10 to 60 mole %, preferably 20 to 40 mole %
d=0 to 20 mole %, preferably 0 to 10 mole %
e=2 to 20 mole %, preferably 1 to 10 mole % and
f=5 to 50 mole %, preferably 15 to 40 mole %.

The polyvinyl acetal polymers of U.S. Pat. No. 6,255,033 used in the present invention can be described as:
(i) tetrafunctional polymers, in which the recurring unit comprises a vinyl acetate moiety and a vinyl alcohol moiety and first and second cyclic acetal groups, or
(ii) pentafunctional polymers in which the recurring unit comprises a vinyl acetate moiety, a vinyl alcohol moiety and first, second and third cyclic acetal group. All three of the acetal groups are six-member cyclic acetal groups. One of them is substituted with an alkyl group, another is subsituted with an aromatic group having a hydroxyl-, or a hydroxyl- and alkoxyl-, or hydroxyl-, and nitro- and bromine-groups; and a third is substituted with a carboxylic acid group, a carboxylic acid substituted alkyl group or a carboxylic acid substituted aryl group.

Examples of suitable aldehydes useful in preparing the first cyclic acetal group of the polyvinyl acetal polymers used in this invention include: acetaldehyde, propionaldehyde, n-butyraldehyde, n-valeraldehyde, n-caproaldehyde, n-heptaldehyde, isobutyraldehyde and isovaleraldehyde, their mixtures and the like. Examples of suitable aldehydes useful in preparing the second cyclic acetal group of the polyvinyl acetal polymers used in this invention include 2-hydroxybenzaldehyde, 3-hydroxybenzaldehyde, 4-hydroxybenzaldehyde, 2-hydroxy-1-naphthaldehyde, 2,4-dihydroxybenzaldehyde, 3,5-dibromo4-hydroxybezaldehyde, 4-oxypropynyl-3-hydroxybenzaldehyde, vanillin, isovanilin and cinnamaldehyde, their mixtures, and the like.

Examples of suitable aldehydes useful in preparing the third cyclic acetal group of the polyvinyl acetal polymers used in this invention include glyoxylic acid, 2-formylphenoxyacetic acid, 3-methoxy-4-formylphenoxy acetic acid and propargyl aldehyde, their mixtures and the like.

This polymer has the advantage that many different functional groups can be incorporated into it to tailor its properties to the specific applications. The long chain alkyl aldehydes may be employed to reduce the softening point (Tg) of the polymer for ease of lamination for a dry film photoresist. Aromatic aldehydes, such as cinnamaldehyde, may be employed to increase the oleophilicity of the composition for use in a printing plate. The polymer compounds used as polymer component(A) in this specification preferably have a weight-average molecular weight of 2,000 to 300,000, and a polydispersity index (weight-average molecular weight/number-average molecular weight) of from 1.1 to 10.

A single polymer may be employed alone as polymer component (A), or two or more types of polymers may be used in combination. The amount thereof is from 30 to 95 weight %, preferably from 40 to 95 weight %, and especially preferably from 50 to 90 weight % of the entire content of solids in the composition. If the added amount of the polymer component (A) is less than 30 weight %, the durability of imageable layer made form the composition deteriorates. If the added amount is more than 95% by weight, the sensitivity to radiation deteriorates.

The developability-enhancing compound, used as component (B), may be any one or more of the following class of compounds:
1. Hydroxyl and thiol-containing compounds such as alcohols, phenols, naphthols, thiols and thiophenols. The alcohols may have an alkyl radical of 12-60 carbon atoms or a fluoroalkyl containing 4-60 carbon atoms or a fluoroalkylaryl containing 7-60 carbon atoms. An example of a suitable polyol is Dimethicone copolyol SF 1488. An example of a monohydric phenol is nonyl phenol. Examples of dihydric phenols are resorcinol and alkyl resorcinols such as 4-hexylresorcinol and n-dodecylresorcinol. Examples of trihydric phenols are: pyrogallol, phloroglucinol, 1,2,4-benzenetriol and their alkyl or fluoroalkyl derivatives. An example of a suitable thiol containing compounds is 1-phenyl-1H-tetrazole-5-thiol. An example of a napthole is 1-Naphthole.
2. An anionic lithium salt that is one of a carboxylate, thiocarboxylate, sulfate, sulfonate, phosphate, phosphite, nitrate and nitrite; Examples of lithium salts of organic acids are lithium 3-(1H,1H,2H,2H-fluoroalkyl) propionate and 3-[(1H,1H,2H,2H-fluoroalkyl)thio]propionate, lithium trifluoromethane sulfonate and lithium perfluorooctylethylsulfonate.
3. Esters and amides of phosphorous-containing acids, preferably having free hydroxyl groups. Examples of phosphorous-containing esters are those with structures P(OH)(OR)₂, P(OH)₂(OR), P(OH)₂[O—R—N(CH₂—CH₂—OH)₂], P(OR)₂[O—R—NH(CH₂—CH₂—OH)₂], where R is an alkyl, aryl, alkylaryl, polyethylene oxide, polypropyleneoxide or combination thereof, and where the R radical may contain fluorine atoms. Other suitable compounds are alkyl phosphonic acids, R—P(O)(OH)₂, as well as their esters and salts, where R is as defined above. Examples of suitable phosphorous-containing amides are P(OH)(ONHR)₂, P(OH)₂(ONHR), P(OR)₂[O—NH(CH₂—CH₂—OH)₂], P(OR)[O—NH(CH₂—CH₂—OH)₂]₂, where R is an alkyl, aryl, polyethylene oxide, polypropyleneoxide and combinations thereof, and where R may contain fluorine atoms.
4. Polysiloxane with free hydroxyl groups. Preferably, the free hydroxyl groups are terminal ones. Examples of suitable compounds are those with structure R[OSi(OCH₃)₂]ₙ—Si(OCH₃)(OH)₂, where R is an alky, aryl, polyethyleneoxide, polypropyleneoxide group or combinations thereof and n is 2 to 1000.
5. Quaternary ammonium salts of phosphorous-containing acids, preferably having free hydroxyl groups. An example of a quaternary ammonium salt containing hydroxyl groups is the diethanolamine salt of perfluoroalkyl substituted polyethyleneoxide phosphite.
6. Compounds containing the azo functional group —N═N— Examples from this class of compounds are:
   azonitriles such a compound is: 2-[(1-cyano-1-methyl)azo] formamide,
   azoamide compounds such as 2,2′-azobis(2-methyl-N-[1,1-bis(hydroxyethyl)-2-hydroxyethyl] propionamide).
   azoamidine and cyclic azoamidine compounds such as 2,2′-azobis(2-amidinopropane)dihydrochloride.
   other azo compounds such as: 2,2′-azobis(2- methyl propionamide oxime).
7. Linear and cyclic compounds containing the following groups:
   —NH—NH—
   and 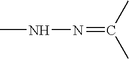
   Examples of the linear compounds are:
   R⁸—NH—NH—R⁹
   and 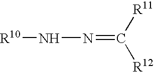
   where
   R¹⁰═CH₃—C₆H₄—SO₂— or C₆H₅—SO₂— and
   R¹⁰, R¹² ═—CₙH₂ₙ₊₁ where n=1 to 20 and
   where R¹ and R² are present in one of the following combinations:
   R⁸═H and R⁹ is one of C₆H₅—SO₂—,
      CH₃—C₆H₄—SO₂—,
      —SO₂—C₆H₄—O—C₆H₄—SO₂—NH—NH₂ and
      —SO₂—C₆H₃(CH₃)—O—C₆H₃(CH₃)—SO₂—NH—NH₂ and
   R⁸═—CONH₂ and R⁹ is one of C₆H₅—SO₂— and CH₃—C₆H₄—SO₂—

Examples of cyclic compound are benzotriazoles, 5-phenyl-1H-tetrazole and 1-phenyl-1H-tetrazole-5-thiol. Some of the above compounds are used as foaming agents.
8. Compounds with the following structures: 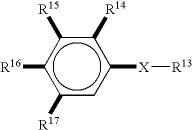
   Where X is one of —S—, S═O, C═O, C—O(NH) or C═O(O) and where R¹³ can be H or C₁ to C₁₂-alkyl, benzyl or structure E, where E is given by 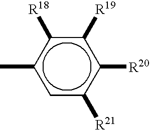
   and where R¹⁴, R¹⁵, R¹⁶, R¹⁷, R¹⁸, R¹⁹, R²⁰, R²¹ can be one of Br, Cl, F, NO₂, H or OH.

Examples of such compounds include 2,2′,4,4′-tetrahydroxy-diphenyl sulphide and 2,2′,4,4′-tetrahydroxy-diphenyl sulphoxide.
9. Substituted aromatic amides, acids and esters of them such as 2,4-dichlorobenzamide, 3-nitrobenzamide, 2-nitrobenzoic acid, 3-nitrobenzoic acid, 2,4-dinitrobenzoic acid, 2,4-dichlorobenzoic acid, 2-hydroxy-1-naphthoic acid, 2,4-dihydroxybenzoic acid, methyl salicylate, pheny Isalicylate, methyl-4-hydroxybenzoate, butyl-4-hydroxybenzoate etc.
10. Sulfones such as dimethylsulfone.

To provide light-absorption of the laser energy in the composition of the present invention, a radiation-to-heat converting compound(C), capable of absorbing incident radiation, preferably infrared radiation, and converting it to heat, is preferably incorporated in the coating composition. The radiation-to-heat converting compounds suitable for the invented heat-sensitive compositions may be chosen from a wide range of organic and inorganic pigments such as carbon blacks, phthalocyanines or metal oxides. Green pigments: Heliogen Green D8730, D 9360, and Fanal Green D 8330 produced by BASF; Predisol 64H-CAB678 produced by Sun Chemicals, and black pigments: Predisol CAB2604, Predisol N1203, Predisol Black CB-C9558 produced by Sun Chemicals Corp., are examples of effective heat absorbing pigments, and other classes of materials absorbing in the near infrared region are known to those skilled in the art. Preferable infrared absorbing materials for use as radiation-to-heat converting compound are those absorbing at wavelengths longer that 700 nm, such as between about 700 and 1300, with near infrared absorbing materials (between about 700 and 1000 nm) being generally used.

For infrared laser sensitive compositions, the dyes that can be used may be any known infrared dyes. Specific examples of dyes which absorb infrared or near infrared rays are, for example, cyanine dyes disclosed in Japanese Patent Application Laid-Open (JP-A) Nos. 58-125246, 59-84356, 59-202829, and 60-78787; methine dyes disclosed in JP-A Nos. 58-173696, 58-181690, and 58-194595; naphthoquinone dyes disclosed in JP-A Nos. 58-112793, 58-224793, 59-48187, 59-73996, 60-52940 and 60-63744; squarylium colorant disclosed in JP-A No. 58-112792; substituted arylbenzo(thio)pyrylium salts described in U.S. Pat. No. 3,881,924; trimethinethia pyrylium salts described in JP-A No. 57-142645 (U.S. Pat. No. 4,327,169); pyrylium-based compounds described in JP-A Nos. 58-181051, 58-220143, 59-41363, 59-84248, 59-84249, 59-146063, and 59-146061; cyanine colorant described in JP-A No. 59-216146; pentamethinethiopyrylium salts described in U.S. Pat. No. 4,283,475; and pyrylium compounds, Epolight III-178, Epolight III-130 and Epolight III-125 described in Japanese Patent Application Publication (JP-B) Nos. 5-13514 and 5-19702 and cyanine dyes disclosed in British Patent No. 434,875.

The pigments or dyes may be added into the radiation sensitive layer for a printing plate, or to other compositions, such as an etch resist in an amount of from 0.01 to 30 weight %, preferably from 0.1 to 10 weight %, and especially preferably from 0.5 to 10 weight % in the case of the dye and from 3 to 13 weight % in the case of a pigment, with respect to the entire amount of solids in the material for the printing plate. If the pigment or dye content is less than 0.01 weight %, sensitivity is lowered. If this content is more than 30 weight %, uniformity of the photosensitive layer is lost and durability or other properties such as etch resistance of the imageable layer deteriorates.

In a further embodiment of the present invention, the positive radiation-sensitive medium of the present invention is prepared without the radiation-to-heat converting compound (C). The radiation-sensitive medium may be incorporated into a positive- working lithographic printing precursor in an imageable layer that is separate from, but adjacent to, the layer comprising the converting compound (C). While it is possible to coat the layer comprising the converting compound (C) on top of the imageable layer comprising the radiation-imageable medium, the preferred arrangement is to have the layer comprising the converting compound (C) sandwiched between the imageable layer and the hydrophilic lithographic base, the imageable layer being transparent to the radiation employed for imaging. When the combined layer structure is illuminated, the layer comprising the converting compound (C) produces heat in the illuminated areas, the heat being then imagewise transferred to the adjacent imageable layer comprising the radiation-sensitive medium. The radiation-sensitive medium then becomes more soluble in alkaline aqueous solution in the imagewise heated areas. The result is a decrease in the energy needed in exposing the composition to obtain a desired level of developability, as compared with a coating that does not contain component (B). The term “hydrophilic lithographic base” is used herein to describe a plate or sheet of material of which at least one surface is hydrophilic, thereby allowing it to hold water or aqueous media, such as fountain solution.

It is possible to have, in place of a separate polymer (A) and infrared absorbing compound, a polymer in which the infrared absorbing material is bonded to the polymer. Examples of these materials are given in U.S. Pat. No. 6,124,425.

A compound that reduces the solubility of the polymer in the alkaline aqueous solution, herein referred to as a “dissolution inhibitor” may optionally be included in the coating composition. Such compounds include, but are not limited to, dyes, particularly infrared dyes such as ADS 830A dye, CAS#134127-48-3 (American Dye Source, Montreal, Canada), and certain image colorants, such as Victoria Pure Blue BO (Basic Blue 7, CAS# 2390-60-5). The use of such compounds is preferred where the inherent solubility of the polymer is relatively high.

In order to achieve processing stability in a broader range of processing conditions, a surfactant may optionally be included in the compositions of the invention. Suitable nonionic surfactants are described in JP-A Nos. 62-251740 and 3-208514 and amphoteric surfactants described in JP-A Nos. 59-121044 and 4-13149. The amount of the nonionic or amphoteric surfactant is preferably from 0.05 to 10 weight percent and more preferably from 0.1 to 5 by weight % of the material for the composition.

A surfactant for improving the applying property, for example, any of the fluorine-containing surfactants such as, for example, Zonyl's (DuPont) or FC-430 or FC-431 (Minnesota Mining and Manufacturing Co.) or alternatively polysiloxanes such as Byk 333 (Byk Chemie), may be added into the infrared sensitive layer. The amount of the surfactant added is preferably from 0.01 to 1 weight % and more preferably from 0.05 to 0.5 weight % of the entire material for the composition.

Image colorants may optionally be included in the compositions of the invention in order to provide a visual image on the exposed plate prior to inking. As the image colorant, dyes other than the aforementioned salt-forming organic dyes may be used. Examples of preferred dyes, including the salt forming organic dyes, are oil-soluble dyes and basic dyes. Specific examples are Oil-Yellow #101, Oil Yellow #103, Oil Pink #312, Oil Green BG, Oil Blue BOS, Oil Blue #603, Oil Black BY, Oil Black BS, Oil Black T-505 (all of which are manufactured by Orient Chemical Industries Co,. Ltd.), Victoria Pure Blue BO, the tetrafluoroborate salt of Basic Blue. Specific examples include Victoria Pure Blue B07, Crystal Violet (CI42555), Methyl Violet (CI42535), Ethyl Violet, Rhodamine B (CI145170B), Malachite Green (CI42000), Methylene Blue (CI52015), or the like. The dyes described in JP-A No. 62-293247 are especially preferred. The dye may be added into the material for the printing plate in an amount of preferably from 0.01 to 10 weight % and more preferably from 0.5 to 8 weight % of the entire solid contents of the material for the composition.

A plasticizer for providing the formed film with softness may be added as needed in the material for the compositions of the invention. The plasticizer may be e.g. butylphthalyl, polyethyleneglycol, tributyl citrate, dibutyl phthalate, dioctyl phthalate, tricresyl phosphate, tributyl phosphate, tetrahydrofurfuryl oleate, an oligomer or polymer of acrylic acid or methacrylic acid, or the like, sorbitan tristearate, sorbitan monopalmitate, sorbitan trioleate, monoglyceride stearate, polyoxyethylene-nonylphenylether, alkyldi(aminoethyl)glycine, alkylpolyaminoethylglycine hydrochloride, 2-alkyl-N-carboxyethyl-N-hydroxyethylimidazolium betaine, N-tetradecyl-N,N-betaine (e.g., trade name Amogen, manufactured by Dai-ichi Kogyo Co., Ltd.), and the like.

Suitable adhesion promoters may optionally be included in the compositions of the invention. Suitable ones include di-acids, triazoles, thiazoles and alkyne containing materials. The adhesion promoters are used in amounts between 0.01 and 3% by weight. Other polymers may be added to reduce the cost of the formulation. Examples include urethane and ketone resins. The amounts of these materials can vary between 0.5% and 25%, preferably between 2% and 20% by weight of solids.

In general, the composition ratio of the polymer component (A) to the component (B) is preferably from 99/1 to 60/40. The developability-enhancing compound(B) must be present in an amount that is effective to significantly increase the sensitivity of the coating to the developer in the radiation-exposed areas of the coating, that is, increased by an amount useful in the image-forming process. If the amount of component (B) is lower than this lowest limit, the component (B) does not significantly improve the sensitivity of the coating. If the amount of component (B) is more than the aforementioned upper limit, the tolerance to developer of unimaged coating is significantly reduced. Thus, both cases are not preferred. More preferred ranges for component (B) are 1.5% to 20% and most preferred ranges are 5% to 15%, measured by weight relative to the total solids in the coating composition.

The positive-working lithographic printing precursor of the present invention can be produced by dissolving the aforementioned respective components into an appropriate solvent, filtering if necessary, and applied from a liquid in a manner known, such as, for example, bar coater coating, spin coating, rotating coating, spray coating, curtain coating, dip coating, air knife coating, blade coating, and roll coating, or the like, onto a hydrophilic lithographic base. Appropriate solvents include methylenechloride, ethylenedichloride, cyclohexanone, methylethyl ketone, acetone, methanol, propanol, ethyleneglycolmonomethylether, 1-methoxy-2-propanol, 2-methoxyethyl acetate, 1-methoxy-2-propyl acetate, dimethoxyethane, methyl lactate, ethyl lactate, and toluene or the like. A single solvent may be used alone, or a combination of two or more solvents may be used. The concentration of the aforementioned components (all of the solid components including the additives) in the solvent is preferably from 1 to 50 weight %. The applied amount (of the solid) on the hydrophilic lithographic base obtained after application and drying differs in accordance with the use, but in general, is preferably from 0.3 to 12.0 grams per square meter according to the application. Lesser amounts can be applied to the hydrophilic lithographic base, resulting in a higher apparent sensitivity, but the film characteristics of the material are deteriorated.

The radiation-sensitive compositions of the present invention are useful for production of printing circuit boards, for lithographic printing plates and other heat-sensitive elements suitable for direct imaging, including but not limited to laser direct imaging (LDI). In the case of lithographic printing, the positive-working lithographic printing precursor of the present invention employs a hydrophilic lithographic base which may, in a general case, comprise a separate hydrophilic layer over a substrate, such that, when the precursor is developed, the hydrophilic coating layer remains, and is employed in the printing process for retaining aqueous media such as fountain solution. In such a case, there is great latitude in choosing a substrate on which to coat the hydrophilic layer. Alternatively, the hydrophilic lithographic base may be of a single material and this material, which may typically be aluminum, may be treated to assure a hydrophilic surface property.

Suitable substrates may include, for example, paper; paper on which plastic such as polyethylene, polypropylene, polystyrene or the like is laminated; a metal plate such as an aluminum, anodized aluminum, zinc or copper plate; a copper foil, reverse treated copper foil, drum side treated copper foil and double treated copper foil clad on a plastic laminate, a plastic film formed of, for example, cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, or polyvinyl acetal; a paper or a plastic film on which the aforementioned metal is vapor-deposited or laminated; glass or glass in which a metal or metal oxide is vapor deposited or the like.

As the substrate in the present embodiment for a printing plate, a polyester film, or an aluminum plate is preferred, and an aluminum plate is especially preferred because of its stable dimensions and relatively low cost. A plastic film on which aluminum is laminated or vapor-deposited may be used. The composition of the aluminum plate applied to the present invention is not specified, and the aluminum plate may be prepared according to any of the known methods, for example of roughening, anodizing and post anodizing treatments. The thickness of the aluminum plate used in the present embodiment is from about 0.1 to 0.6 mm, preferably from 0.15 to 0.5 mm.

The positive-working lithographic printing precursor produced as described above is usually subjected to image-exposure and developing processes. In a preferred embodiment, radiation-sensitive compositions as described above are applied as a coating on a hydrophilic lithographic base (for example an aluminum plate) to form a lithographic printing precursor. The precursor can be imaged (for example by imagewise exposure to infrared radiation), and the imaged precursor developed to form a positive-working lithographic printing plate, using a conventional alkaline aqueous developer solution. When the precursor has a separate imageable layer and layer comprising the converter substance, the development process removes both layers, to reveal the underlying hydrophilic surface.

In a preferred embodiment of the invention, the light source for an active light beam which is used in the image-exposure, is preferably a light source emitting light having a luminous wavelength within the range from the near infrared wavelength region to the infrared wavelength region, and is especially preferably a solid state laser or a semiconductor laser. Preferably, the positive-working lithographic printing precursor based on the radiation-sensitive medium of the present invention is sensitive to radiation of wavelength between 700 nm and 1300 nm, and more preferably between 700 nm and 1000 nm.

The developing solution and replenishing solution for the positive-working lithographic printing precursor of the present invention may be a conventionally known alkali aqueous solution such as, for example, sodium metasilicate, potassium tertiary phosphate, ammonium secondary phosphate, sodium carbonate, potassium borate, sodium hydroxide, ammonium hydroxide, potassium hydroxide, tetraalkylammonium hydroxides; and organic alkali agents such as, alkyl amines, alkyl ethanolamines or diamines. The alkali agent may be used alone, or a combination of two or more may be used.

Among these, especially preferred developing solutions are aqueous solutions of silicates and hydroxides. It is known that when development is carried out by using an automatic developing machine, an aqueous solution (a replenishing solution) having a higher basicity than that of the developing solution is added to the developing solution so that many plates or pieces of can be processed without having to replace the developing solution in the developing tank for a long time. In the present embodiment, such a replenishing manner is preferably used. Various surfactants or organic solvents may be optionally added to the developing solution and the replenishing solution to accelerate or control developability, improve the dispersibility of development-scum, and/or improve the affinity of image portions on the printing plate with ink. Other agents commonly used in positive plate developers may also be included in the developer solution.

The composition is usually post-processed with water; optionally containing, for example, a surfactant. In the case of printing plates a desensitizing solution containing gum arabic or a starch derivative is used. Various combinations of these treatments can be used as the post-processing carried out when the imageable medium of the present embodiment is used in its different applications.

Preparation of the Acetal Polymers Employed in the Present Invention.

Acetalization of the polyvinyl alcohols takes place according to known standard methods as described, for example, in U.S. Pat. No. 4,665,124; U.S. Pat. No. 4,940,646; U.S. Pat. No. 5,169,898; U.S. Pat. No. 5,700,619; U.S. Pat. No. 5,792,823; JP 09,328,519 etc. In U.S. Pat. No. 6,255,033, Levanon et al. provide detailed synthesis examples for the acetal polymers used in the present invention.

Polymer 1

In a preferred embodiment of the present invention, the polymer employed as polymer component (A) is derived from 3-hydroxybenzaldehyde and butyraldehyde by the following process, resulting in a polyvinyl acetal resin having butyral acetal groups and hydroxy-substituted aromatic acetal groups, herein referred to as polymer 1, the hydroxy-substitution being on the 3-position on the aromatic ring:

100 grams of Airvol 103 polyvinyl alcohol (a 98% hydrolyzed polyvinyl acetate having a number average molecular weight of about 15,000), was added to a closed reaction vessel fitted with a water-cooled condenser, a dropping funnel and thermometer, and containing 150 grams of demineralized water and 25 grams of methanol. With continual stirring, the mixture was heated for 0.5 hour at 90° C until it became a clear solution. After this, the temperature was adjusted to 60° C. and 3 grams of concentrated sulfuric acid in 50 grams of methanol were added. Over a 15 minutes period, a solution of 60 grams of 3-hydroxybenzaldehyde and 1.4 grams of 2,6-di-t-butyl-4-methylphenol in 450 grams of Dowanol PM™ were added in a drop-wise manner. The reaction mixture was diluted with additional 200 grams of Dowanol PM™, and 23.2 grams of n-butyraldehyde in 200 grams of Dowanol PM™ were added in a dropwise manner, upon complete addition of the aldehydes, the reaction was continued at 50° C. for additional 3 hours. At this stage the conversion of the butyraldhyde is completed and the conversion of the 3-hydroxybenzaldehyde is close to 50%. The water-Dowanol PM™ azeotrope is distilled out from the reaction mixture in vacuum, Dowanol PM™ is added to the reaction mixture during the distillation. The distillation is complete when the water content of the reaction mixture is lower than 0.1%. The conversion of the 3-hydroxybenzaldehyde is higher than 97%. The reaction mixture is precipitated in water. The resulting polymer is filtered, washed with water and dried at 60° C. for 3 days to a water content of 2%.

Polymer 2

In a preferred embodiment of the present invention, the polymer employed as polymer component (A) is derived from 3-hydroxybenzaldehyde, butyraldehyde and cinnamaldehyde by, resulting in a polyvinyl acetal resin having butyral acetal groups, cinnamal acetal groups and hydroxy-substituted aromatic acetal groups, herein referred to as polymer 2, the hydroxy-substitution being in the 3-position on the aromatic ring.The preparation of polymer 2 is identical to that of polymer 1, except that addition of the 3-hydroxybenzaldehyde is followed by addition of 14,7 grams of cinnamaldehyde in 150 g of Dowanol PM™ and followed by 16 grams of butyraldehyde in 200 g of Dowanol PM™. The presence of cinnamaldehyde in the composition of polymer 2 is thought to improve the ink-attracting ability of the imageable areas of the plate.

Polymer 3

In a preferred embodiment of the present invention, the polymer employed as polymer component (A) is derived from 2-hydroxybenzaldehyde and butyraldehyde, resulting in a polyvinyl acetal resin having butyral acetal groups and hydroxy-substituted aromatic acetal groups, herein referred to as polymer 3, the hydroxy-substitution being on the 2-position of the aromatic ring. The preparation of polymer 3 is identical to that of polymer 1 except that the Airvol 103 polyvinyl alcohol was replaced by Poval 103 and 5 2-hydroxybenzaldehyde (90 grams in 500 grams of Dowanol PM™) was used instead of the 3-hydroxybenzaldehyde followed by addition of 12 grams of butyraldehyde in 200 grams of Dowanol PM™.

Polymer 4

In a preferred embodiment of the present invention, the polymer employed as polymer component (A) is derived from 2-hydroxybenzaldehyde and butyraldehyde, resulting in a polyvinyl acetal resin having butyral acetal groups and hydroxy-substituted aromatic acetal groups, herein referred to as polymer 4, the hydroxy-substitution being on the 2-position of the aromatic ring. The preparation of polymer 4 is identical to that of polymer 3 except that the amount of 2-hydroxybenzaldehyde used was 68 grams and the amount of the n-butyraldehyde was 23.2 grams.

### EXAMPLES

The following examples illustrate aspects of the invention. Materials were obtained from the following sources:
Airvol 103 (trademark), a polyvinyl alcohol product from Hoechst, Germany. Clariant, U.S.
Tween 80K (trademark) from Avecia of Manchester, UK.
ADS 830A and ADS 830WS (trademarks) IR dyes from American Dye Source, Montreal, QC, Canada.
Phosphate esters, Zelec 8172 and 8175 (trademarks) from Stepan UK Ltd, Cheshire, UK.
Zonyl FSA (trademark) from DuPont Canada Inc., Missisauga, ON, Canada.
Silicone acrylate VS-80 (trademark) from 3M, St. Paul, Minn., USA.
Dimethicone copolyol SF1488 (trademark) from GE Silicones, Waterford, N.Y., USA.
Goldstar Plus (trademark) positive plate developer from Kodak Polychrome, Mississauga, ON, Canada.

### Comparative Example 1.

This example shows results obtained when no developability-enhancing compound is added to the composition of the present invention.

| Components | Weight, % |
|---|---|
| Polymer 3 or 4 | 75 |
| Developability-enhancing compound | 0 |
| Resole resin LB 9900* | 20 |
| IR dye | 2 |
| Colorant - Victoria Blue R | 2.5 |
| N,N-Diethylaniline | 0.5 |

The components of the composition were dissolved in mixture of MEK: Dowanol PM™, filtered and coated on the surface of anodized aluminum. After drying the resulting plate has a dry coating weight of 1.5 grams/m². The plate was imaged in the Creo Lotem 400 Quantum at 490 rpm with power densities from 6 to 18 W. The plate was developed in 8.4% potassium methasilicate solution in water for 30 seconds, rinsed off with water and dried. The energy density required to give a clear background is 230 mJ/cm² for polymer 3 (drying 2.5 mins/100° C.) and 240 mJ/cm² for polymer 4 (drying 3 mins/95° C.). The % coating weight loss from unexposed areas of the plate was <15.

### Application Examples 1-15.

| Components | Weight, % |
|---|---|
| Polymer 3 or 4 | 55 |
| Developability-enhancing compound | 20 |
| (see in table 1.) | |
| Resole resin LB 9900* | 20 |
| IR dye | 2 |
| Colorant - Victoria Blue R | 2.5 |
| N,N-Diethylaniline | 0.5 |

The components of the composition were dissolved in MEK: Dowanol PM™ mixture, filtered and coated on the surface of anodized aluminum. After drying the resulting plate has a dry coating weight of 1.5 grams/m². The plate was imaged in the Creo Lotem 400 Quantum at 490 rpm with power densities from 6 to 18 W. The plate was developed in 8.4% potassium methasilicate solution in water for 30 seconds, rinsed off with water and dried. The energy density required to give a clear background is given in table 1.

TABLE 1

| | | DRYING | |
|---|---|---|---|
| Developability-enhancing | | Time (min)/ | SENSITIVITY, |
| compound | POLYMER | Temp.(° C.) | (mJ/cm²) |
| Hydroquinone | 4 | 2/110 | 50 |
| Resorcinol | 4 | 2.5/105 | 50 |
| Tert-butyl-hydroquinone | 4 | 2.5/110 | 50 |
| Methyl salicylate | 4 | 2/105 | 90 |
| Phenyl Salicylate | 4 | 2/110 | 80 |
| Benzyl-4-hydroxybenzoate | 3 | 3/110 | 90 |
| Butyl-4-hydroxybenzoate | 3 | 2/110 | 50 |
| Methyl-4-hydroxybenzoate | 3 | 3/110 | 50 |
| Methyl-4-hydroxybenzoate | 4 | 2/110 | 50 |
| 4-hexylresorcinol | 4 | 2/115 | 50 |
| 2′,4′- | 4 | 2.5/105 | 50 |
| Dihydroxyacetophenone | | | |
| 5-phenyl-1H-tetrazole | 4 | 2.5105 | 50 |
| Dimethylsulfone | 3 | 2/100 | 70 |
| Resorcinol monobenzoate | 3 | 2/115 | 50 |
| 1-Naphthole | 4 | 2.5/105 | 50 |

All unexposed areas of plate in table 1 had a % weight loss of<15.

### Application Examples 16-31.

| Components | Weight, % |
|---|---|
| Polymer 3 or 4 or 1 | 65 |
| Developability-enhancing compound | 10 |
| (see in table 1.) | |
| Resole resin LB 9900* | 20 |
| IR dye | 2 |
| Colorant - Victoria Blue R | 2.5 |
| N,N-Diethylaniline | 0.5 |

The components of the composition were dissolved in MEK: Dowanol PM™ mixture, filtered and coated on the surface of anodized aluminum. After drying the resulting plate has a coating weight of 1.5 grams/m² dry thickness. The plate was imaged in the Creo Lotem 400 Quantum at 490 rpm with power densities from 6 to 18 W. The plate was developed in 8.4% sodium methasilicate solution in water for 30 seconds, rinsed off with water and dried. The energy density required to give a clear background is given in table 2.

TABLE 2

| | | Drying | |
|---|---|---|---|
| Developability-enhancing | | Time (min)/ | Sensitivity |
| compound | Polymer | Temp(° C.) | (mJ/cm²) |
| (2′-Hydroxyethyl)-2,4- | 4 | 2.5/100 | 90 |
| dihydroxybenzamide | | | |
| 2,2′,4,4′-Tetrahydroxy-diphenyl | 4 | 2.5/110 | 80 |
| sulphide | | | |
| 2,2′,4,4′-Tetrahydroxy-diphenyl | 4 | 2.5/100 | 70 |
| sulphoxide | | | |
| 2′,3′,4′-Trihydroxybenzophenone | 4 | 3/90 | 90 |
| 2,4-Dihydroxybenzoic acid | 4 | 3/115 | 50 |
| Propyl gallate | 4 | 2/90 | 80 |
| Hydroquinone | 4 | 2/110 | 50 |
| Pyrrogallol | 4 | 2.5/105 | 50 |
| 2-Nitrobenzoic acid | 4 | 2.5/105 | 50 |
| 3-Nitrobenzoic acid | 4 | 2.5/105 | 60 |
| 4-Nitrobenzoic acid | 4 | 2.5/105 | 50 |
| 2,4-Dinitrobenzoic acid | 4 | 2.5/105 | 60 |
| 2,4-Dichlorobenzoic acid | 4 | 2.5/105 | 60 |
| 2-Hydroxy-1-napthoic acid | 4 | 2.5/105 | 70 |
| 3-Hydroxy-2-napthoic acid | 4 | 2.5/105 | 60 |
| 3-Nitrobenzamide | 4 | 2.5/105 | 70 |

All unexposed areas of plate in table 2 had a % weight loss of <15.

### Application Example 32-35.

| Component | Weight, % |
|---|---|
| Polymer 3 or 4 | 60 |
| Developability-enhancing compound (see in table1.) | 15 |
| Resole resin LB 9900* | 20 |
| IR dye | 2 |
| Colorant - Victoria Blue R | 2.5 |
| N,N-Diethylaniline | 0.5 |

The components of the composition were dissolved in MEK: Dowanol PM™ mixture, filtered and coated on the surface of anodized aluminum. After drying the resulting plate has a coating weight of 1.5 grams/m² dry thickness. The plate was imaged in the Creo Lotem 400 Quantum at 490 rpm with power densities from 6 to 18 W. The plate was developed in 8.4% potassium methasilicate solution in water for 30 seconds, rinsed off with water and dried. The energy density required to give a clear background see in table3.

TABLE 3

| | | DRYING | |
|---|---|---|---|
| Developability-enhancing | POLY- | Time (min)/ | SENSITIVITY |
| compound | MER | Temp.(° C.) | (mJ/cm²) |
| 2,4-Dihydroxybenzoic | 3 | 2/105 | 70 |
| acid methyl ester | | | |
| 2,4-Dihydroxybenzophenone | 4 | 2/105 | 90 |
| Benzotriazole | 4 | 2.5/105 | 60 |
| 2-(carbamoylazo)isobutyronitrile | 4 | 2.5/105 | 50 |

All unexposed areas of plate in table 3 had a % weight loss of <15.

### Application Example 36.

| Component | Weight, % |
|---|---|
| Polymer 4 | 79.2 |
| Hydroxyphenol tetrazol-thiol | 10 |
| IR dye | 2 |
| Colorant - Victoria Blue R | 3.5 |
| Benzoflex 2160 | 5 |
| N,N-Diethylaniline | 0.3 |

The components of the composition were dissolved in MEK: Dowanol PM™ mixture, filtered and coated on the surface of anodized aluminum. After drying for 3 minutes at 90° C. the resulting plate has a coating weight of 1.5 grams/m² dry thickness. The plate was imaged in the Creo Lotem 400 Quantum at 490 rpm with power densities from 6 to 18 W. The plate was developed in 5.5% sodium methasilicate solution in water for 30 seconds, rinsed off with water and dried. The energy density required to give a clear background was 70 mJ/cm². The % coating weight loss from unexposed areas of the plate was <15.

### Comparative Example 37

This is a reference example containing no developability-enhancing compound.

A coating solution was made of the following additives (wt %):
polymer 1 polymer 2, 45:55, 87.5%;
a cyanine dye with the formula C₄₇H₄₇ClN₂O₃S, CAS#134127-48-3, 1% as an infrared absorber;
an image colorant Victoria Pure Blue BO (Basic Blue 7, CAS# 2390-60-5) in the amount of 6.5%;
a polyethylene glycol sorbitan ester, Tween-80, with a degree of polymerization 80,s as 5%.

The coating solution was made in acetone: methoxypropanol (Dowanol PM), 75:25 and had a percentage of solids of 10%. A printing plate was cast manually on anodized aluminum substrate with a casting rod #12 (coating weight 1.75-1.8 g/m²). The plate was dried at 13020 C. in a traveling oven (Wisconsin model SPC MINI-34/121) for 3 min.

The plate was then imaged using a Creo Quantum 800 (trademark) imagesetter with 12 W radiation, wavelength 830 nm and an energy density series between 180-400 mJ/cm² in increments of 20 mJ/cm² under the form of solid image squares. The plate was developed in a Glunz-Jensen 85 HD processor in an alkaline developer containing 7% sodium metasilicate of conductivity 66 mS/cm. The developing conditions were: 24° C., 30s passing time, and 50° C. drying. The developed plate revealed squares of bare substrate where the optical density was measured with an optical densitometer. The clearing point was defined as the energy at which the optical density (OD) difference between the area of cleared substrate and the original uncoated substrate was 0.01 or less. The plate prepared under this example had a clearing point of 350 mJ/cm² and a % weight loss in developer of <50. The weight loss in developer refers to the non-irradiated area.

### Example 38

The following coating composition was prepared:
polymer 1:polymer 2, 45:55, 84.5%, both prepared as per example 28
infrared dye 1%
Basic Blue 7, 6.5%
Tween-80, 5%
Lithium trifluoromethane sulfonate, 3%

A coating solution containing 10% solids was prepared with the above formula. Plates were cast manually on anodized aluminum with the solution in Example 28 (reference) and in the above solution. The plates were dried at 125° C. for 3 min. A coating weight of 1.8 g/m² was obtained. The plate was imaged in a Creo Quantum 800 imagesetter with 12 W radiation and a wavelength of 830 nm. The image was a series of solid squares irradiated with an energy density between 120-360 mJ/cm² in increments of 20 mJ/cm². The plates were developed in a developer containing 7% sodium metasilicate (conductivity 66 mS/cm) at 23° C., using a residence time in the processor of 30 s. The plate with lithium trifluoromethane sulfonate development-enhancer had a clearing point of 140 mJ/cm² and a % weight loss in developer of <50 as compared with the reference without developability-enhancing compound, which had a clearing point of 320 mJ/cm² and a non-irradiated % coating weight loss of <50.

### Example 39

A coating was made with the composition:
polymer 1:polymer 2,1:1, 77.5%
Basic Blue 7, 6.5%
IR dye 1%
Tween-80 5%
Zelec 8175, 10%

The coating solution was made at 10% solids in acetone: Dowanol PM, 75:25. A plate with a coating weight of 1.65-1.75 g/m² was cast with this solution. A reference plate with the reference solution in Example 28 was cast at the same time. The two plates were dried at 125° C. for 2 min. The plates were imaged in Creo's Quantum 800 imagesetter with 12 W radiation of wavelength 830 nm and an energy density series between 120-360 mJ/cm² in increments of 20 mJ/cm². The plates were developed in Goldstar positive plate developer diluted to 90% of its original concentration, at 23° C., for 30 s. The plate with Zelec 8175 development-enhancer had a clearing point of 110 mJ/cm² and a % weight loss in developer of <50 as compared with the reference plate without developability-enhancing compound that had 320 mJ/cm² clearing point and a non-irradiated % coating weight loss of <50.

### Example 40

A coating was made with the composition:
polymer 1:polymer 2,1:1, 77.5%
Basic Blue 7, 6.5%
IR dye 1%
Tween-80 5%
Zelec 8172, 10%

Two plates were cast manually, one with the above solution containing Zelec 8172 as a development-enhancer and one with the reference solution in Example 28 without development-enhancer. The plates had a coating weight of 1.7-1.8 g/m². The plates were dried at 125° C., 2 min and imaged with 12 W an energy series between 80-300 mJ/cm². The plates were developed in 60% Goldstar at 23° C., 30 s. The clearing point and % weight loss in developer were 140 mJ/cm² and <50, respectively for the plate containing Zelec 8172 while the reference plate without developability-enhancing compound did not clear up to 300 mJ/cm².

### Example 41

A coating was made containing the following additives:
Polymer 1:Polymer 2, 1:1, 86%.
IR dye 1%
Basic Blue 7, 6.5%
Tween-80, 5%
Lithium 3-[(1H,1H,2H,2H-fluoroalkyl)thio]propionate (Zonyl FSA from DuPont), 1.5%

A coating with the above formula and a reference coating as in Example 28 containing the same ingredients except Zonyl FSA were prepared. The coating solutions were made in Dowanol PM at 10% solids. Plates were cast manually on anodized aluminum substrate and baked at 125° C., for 2.5 min. The coating weight was determined as 1.7-1.8 g.m². The plates were imaged in identical conditions: power 11 W and an energy density series of 100-350 mJ/cm². The plates were developed in a developer containing 7.2% sodium metasilicate (conductivity 66 mS) at 24° C. and 30 s residence time in developer. The reference plate containing no developability-enhancing compound had a clearing point of 320 mJ/cm² and a % weight loss in developer of <50, while the plate containing 1.5% FSA had a clearing point of 130 mJ/cm² and a non-irradiated % coating weight loss of<50.

### Example 42

A plate was made with a coating containing 7% n-dodecyl resorcinol and compared with a reference plate.

The coating in this example had the following composition:
Polymer 1: polymer2,1:1, 80.5%
Basic Blue 7, 6.5%
IR dye 1%
Tween-80, 5%
n-Dodecyl resorcinol, 7%

The coating solution in this example and the reference coating (as in Example 28) were made in acetone: Dowanol PM, 75:25 at 10% solids. The solutions were cast with a rod on anodized aluminum substrate. The resulting plates were baked at 130° C. for 3 min. The coating weight was 1.7 g/m². The plates were exposed to a 830 nm IR laser radiation at a power of 8 W and an energy density series of 90-400 mJ/cm². The plates were developed in a DuPont-Howson processor in a developer containing 7% sodium metasilicate of conductivity 71 mS/cm in the following conditions: 23° C. and 30 s residence time. The plate with n-dodecyl resorcinol showed a clearing point of 160 mJ/cm² and a non-irradiated % coating weight loss of <50 as compared to the reference plate which showed 350 mJ/cm² clearing point and a non-irradiated % coating weight loss of <50.

### Example 43

The composition of the coating with the silicone compound is the following:
Polymer 1:polymer 2,1:1, 82.5%
Basic Blue 7, 6.5%
IR dye 1%
Tween-80, 5%
Silicone acrylate VS-80, 5%

A reference coating without developability-enhancing compound as in Example 28 was used for comparison. The solutions were made in acetone: Dowanol PM, 75:25 at 10% solids. Plates were cast manually and were baked at 130° C./3 min. The coating weight was 1.8-1.85 g/m². The plates were imaged with 12 W and an energy series of 90-350 mJ/cm². The plates were developed in Goldstar (Kodak) positive plate developer in a DuPont-Howson processor in the following conditions: 23° C. and 30 s passing time. The plate with silicone acrylate developability-enhancing compound had a clearing point of 150 mJ/cm² and a non-irradiated % coating weight loss of <50 as compared to 300 mJ/cm² and a non-irradiated % coating weight loss of <50 for the reference.

### Example 44

A coating composition with the following composition was prepared:
Polymer 1:polymer 2,1:1, 77.5%
Tetrafluoroborate salt of Basic Blue 7, 6.5%
IR dye 1%
Tween-80, 5%
Resorcinol, 10%

A reference coating without developability-enhancing compound as in Example 28 was used for comparison. The coating solutions were made in acetone: Dowanol PM, 75:25 at 10% solids. For this Example, a dye was prepared and used that is based on the triarylmethane dye Basic Blue 7 (CAS number 371231-05-9). Specifically the tetrafluoroborate (BF₄—) salt of Basic Blue 7 was used. Plates were cast manually with a casting rod and were dried at 130° C./3 min. The coating weight was 1.8-1.85 g/m². The plates were imaged with 12 W and an energy series of 90-350 mJ/cm². The plates were developed in a developer containing 7% sodium metasilicate (conductivity 66 mS/cm) in a DuPont-Howson processor in the following conditions: 26° C. and 30 s passing time. The plate with resorcinol developability-enhancing compound had a clearing point of 150 mJ/cm² and a non-irradiated % coating weight loss of <50 as compared to 350 mJ/cm² and a non-irradiated % coating weight loss of <50 for the reference plate.

### Example 45

A plate was made with a coating containing 5% 4-hexyl resorcinol having the composition in Table 4. A reference coating with no developability-enhancing compound having the composition in Table 1 was also prepared. The coating solutions were made in acetone: Dowanol PM, 75:25 at 10% solids. The solutions were cast with a rod on anodized aluminum substrate. The resulting plates were baked at 130° C. for 3 min. The plates were exposed to 830 nm IR laser radiation a power of 8 W and an energy density series of 90-350 mJ/cm². The plates were developed in a DuPont-Howson processor in a developer containing 7% sodium metasilicate of conductivity 71 mS/cm in the following conditions: 23° C. and 30 s residence time. The plate with 4-hexyl resorcinol showed a clearing point of 150 mJ/cm² and a non-irradiated coating % weight loss of <50. This compares to the reference plate with no developability-enhancing compound cleared at 320 mJ/cm² and had a non-irradiated % coating weight loss of <50.

TABLE 4

| | Reference | Example 9 |
|---|---|---|
| Polymer1:Polymer 2, 54:46 | 87.5 | 82.5 |
| IR dye | 1 | 1 |
| Basic Blue 7 | 6.5 | 6.5 |
| Tween-80 | 5 | 5 |
| 4-hexyl resorcinol | — | 5 |
| Clearing point, mJ/cm² | 320 | 150 |
| Weight loss in developer, % | 17 | 27 |

### Example 46

Two plates were made, one containing 5% dimethicone copolyol SF 1488 in the composition and a reference plate with no developability-enhancing compound (Table 5).

The solutions were made in acetone: Dowanol PM, 75:25 at 10% solids. Plates were cast manually and baked at 130° C./3 min. The coating weight was 1.8-1.85 g/m². The plates were imaged at 12 W an energy series of 90-350 mJ/cm². The plates were developed in Goldstar positive plate developer in a DuPont-Howson processor at 23° C. and 30 s passing time. Table 5 shows that SF1488 at 5% level brings a clearing point of 160mJ/cm² and a non-irradiated % coating weight loss of<50 as compared to 320mJ/cm² and a non-irradiated % coating weight loss of <50 for the reference.

TABLE 5

| | Reference | Example 10 |
|---|---|---|
| Polymer1:Polymer 2, 46:54 | 86 | 82.5 |
| IR dye | 1 | 1 |
| Basic Blue 7 | 8 | 6.5 |
| Tween-80 | 5 | 5 |
| Dimethicone copolyol SF 1488 | — | 5 |
| Clearing point, mJ/cm² | 320 | 160 |
| Weight loss in developer, % | 20 | 25 |

### Example 47

Two coating solutions were prepared as follows.

Solution 1: Polymer 1: polymer 2, 1:1, 78%
Hexyl resorcinol, 10%
Basic Blue 7, 7%
Tween-80, 5%
The solution was made in Dowanol PM at 10% solids.

Solution 2: 1 kg of phenol formaldehyde resin was prepared in-house having a phenol:formaldehyde molar ratio of 0.9:1 using an acid catalyst, sulfuric acid. The resin solution had a pH=5 and a solids content of 10%. 1 g IR dye ADS 830WS was dissolved in 100 g ethanol and added under stirring to the phenol-formaldehyde resin solution.

Solution 1 was coated on anodized aluminum substrate by spraying. The coating weight was 1.6 g/m². Solution 2 was then spray-coated on top of the coating from solution 1 giving an additional coating weight of 0.5 g/cm². The resulting plate was baked at 125° C. for 2.5 min. The plate was imaged at 830 nm with Creo's Quantum 800 imagesetter a series of energy density between 90-300 mJ/cm² and a power of 12 W. The plate was developed in a DuPont processor containing an alkaline developer made from a 7% sodium silicate solution of 66 mS/cm. The plate was developed for 30 s at 26° C. The plate had a clearing point of 150 mJ/cm² and a non-irradiated % coating weight loss of <50.

There have thus been outlined the important features of the invention in order that it may be better understood, and in order that the present contribution to the art may be better appreciated. Those skilled in the art will appreciate that the conception on which this disclosure is based may readily be utilized as a basis for the design of other methods and apparatus for carrying out the several purposes of the invention. It is most important, therefore, that this disclosure be regarded as including such equivalent methods and apparatus as do not depart from the spirit and scope of the invention.

1. A radiation-sensitive composition comprising
a. an acetal resin derived from polyvinyl alcohol by condensation with aldehydes and
b. a developability-enhancing compound.

2. The composition of claim 1, further comprising a radiation-to-heat converting compound.

3. The composition of claim 2, in which the radiation-to-heat converting compound is an infrared light-to-heat converting compound.

4. The composition of claim 3, further comprising a dissolution inhibitor.

5. A composition according to claim 1, wherein the developability-enhancing compound is at least one of
a. an alcohol having at least one of an alkyl radical of 12-60 carbon atoms, a fluoroalkyl radical of 4-60 carbon atoms and a fluoroalkylaryl radical of 7-60 carbon atoms;
b. a polyol;
c. a monohydric phenol;
d. a polyhydric phenol;
e. a compound containing thiol functionality;
f. an anionic lithium salt that is one of a carboxylate, thiocarboxylate, sulfate, sulfonate, phosphate, phosphite, nitrate and nitrite;
g. an ester of a phosphorous-containing acid;
h. an amide of a phosphorus containing acid;
i. a polysiloxane;
j. a quaternary ammonium salt having a free hydroxyl group.
k. an azo compound;
l. a compound containing —NH—NH— functionality;
m. a compound containing —NH—N═C functionality;
n. a compound containing the structure 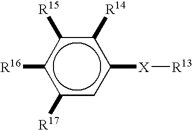
where X is one of —S—, S═O, C═O or CO₂ and where R¹³ can be a C₁ to C₁₂ alkyl, benzyl or structure E, where E is given by 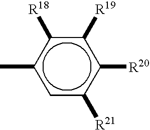
and where R¹⁴, R¹⁵, R¹⁶, R¹⁷, R¹⁸, R¹⁹, R²⁰, R²¹ can be one of H and OH.
o. a substituted aromatic acid;
p. a substituted aromatic ester;
q. a substituted aromatic amide and
r. a compound containing sulfone functionality.

6. A composition according to claim 5, wherein the polyol is dimethicone copolyol.

7. A composition according to claim 5, wherein the polyhydric phenol is at least one of resorcinol, 4-hexylresorcinol, n-dodecylresorcinol and 1-naphthole.

8. A composition according to claim 5, wherein the polyhydric phenol is one of pyrogallol, phloroglucinol, 1,2,4-benzenetriol and their alkyl and fluoroalkyl derivatives.

9. A composition according to claim 5, wherein the anionic lithium salt is one of lithium 3-(1H,1H,2H,2H-fluoroalkyl) propionate and 3-[(1H,1H,2H,2H -fluoroalkyl)thio]propionate, lithium trifluoromethane sulfonate and lithium perfluorooctylethylsulfonate.

10. A composition according to claim 5, wherein the ester of a phosphorous-containing acid is one of P(OH)(OR)₂, P(OH)₂(OR), P(OH)₂[O—R—N(CH₂—CH₂—OH)₂], P(OR)₂[O—R—NH(CH₂—CH₂—OH)₂], where R is an alkyl, aryl, alkylaryl, polyethylene oxide, polypropyleneoxide or combination thereof.

11. A composition according to claim 5, wherein the ester of a phosphorus containing acid is a nonylphenol phosphate ester.

12. A composition according to claim 5, wherein the amide of a phosphorous-containing acid is one of P(OH)(ONHR)₂, P(OH)₂(ONHR), P(OR)₂[O—NH(CH₂—CH₂—OH)₂], P(OR)[O—NH(CH₂—CH₂—OH)₂]₂, where R is an alkyl, aryl, polyethylene oxide, polypropyleneoxide or combination thereof.

13. A composition according to claim 5, wherein the polysiloxane is R[OSi(OCH₃)₂]ₙ—Si(OCH₃)(OH)₂ where R is an alky, aryl, polyethyleneoxide, polypropyleneoxide group or combination thereof and n=2-1000.

14. A composition according to claim 5, wherein the substituted aromatic acid is at least one of 2-nitrobenzoic acid, 3-Nitrobenzoic acid, 4-Nitrobenzoic acid, 2,4-Dinitrobenzoic acid, 2,4-Dichlorobenzoic acid, 2-Hydroxy-1-napthoic acid and 3-Hydroxy-2-napthoic acid.

15. A composition according to claim 5, wherein the substituted aromatic ester is methyl salicylate, phenyl salicylate, benzyl-4-hydroxybenzoate, Butyl-4-hydroxybenzoate and methyl-4-hydroxy benzoate.

16. A composition according to claim 5, wherein the substituted aromatic amide is 3-nitrobenzamide and (2′-Hydroxyethyl)-2,4-dihydroxybenzamide.

17. The composition of claim 1, wherein the acetal resin has the structure 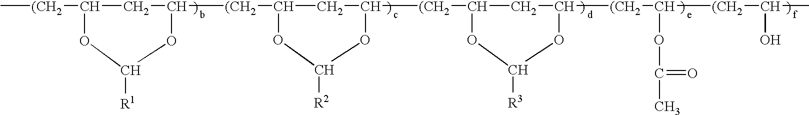
in which R¹ is —CₙH₂ₙ₊1 where n=1 to 12, and R² is 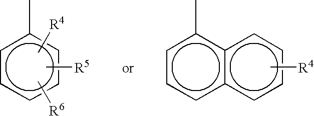
wherein R⁴═—OH;
R⁵═—OH or —OCH₃ or Br— or —O—CH₂—C≡CH and
B⁶═Br— or NO₂
R³═—(CH₂)ₜ—COOH, —C≡CH, or 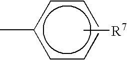
where R⁷═COOH, —(CH₂)ₜ—COOH, —O—(CH₂)ₜ—COOH
and in which t=1 to 4, and where b=5 to 40 mole %, preferably 15 to 35 mole %
c=10 to 60 mole %, preferably 20 to 40 mole %
d=0 to 20 mole %, preferably 0 to 10 mole %
e=2 to 20 mole %, preferably 1 to 10 mole %
and f=5 to 50 mole %, preferably 15 to 40 mole %.

18. A composition according to claim 17, wherein the developability-enhancing compound is at least one of
a. an alcohol having at least one of an alkyl radical of 12-60 carbon atoms, a fluoroalkyl radical of 4-60 carbon atoms and a fluoroalkylaryl radical of 7-60 carbon atoms;
b. a polyol;
c. a monohydric phenol;
d. a polyhydric phenol;
e. a compound containing thiol functionality;
f. an anionic lithium salt that is one of a carboxylate, thiocarboxylate, sulfate, sulfonate, phosphate, phosphite, nitrate and nitrite;
g. an ester of a phosphorous-containing acid;
h. an amide of a phosphorus containing acid;
i. a polysiloxane;
j. a quaternary ammonium salt having a free hydroxyl group
k. an azo compound;
l. a compound containing —NH—NH— functionality;
m. a compound containing —NH—N═C [symbol] functionality;
n. a compound containing the structure 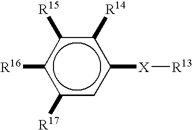
where X is one of —S—, S═O , C═O or CO₂ and where R¹³ can be a C₁ to C₁₂ alkyl, benzyl or structure E, where E is given by 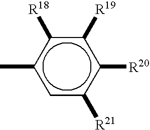
and where R¹⁴, R¹⁵, R¹⁶, R¹⁷, R¹⁸, R¹⁹, R²⁰, R²¹ can be one of H and OH.
o. a substituted aromatic acid;
p. a substituted aromatic ester;
q. a substituted aromatic amide and
r. a compound containing sulfone functionality.

19. A composition according to claim 18, wherein the polyhydric phenol is at least one of resorcinol, 4-hexylresorcinol, n-dodecylresorcinol and 1-naphthole.

20. A radiation-sensitive composition comprising:
a. at least one of resorcinol, n-dodecyl resorcinol, 4-hexyl resorcinol and 1-naphthole,
b. an acetal resin formed by the condensation of polyvinyl alcohol with aldehydes,
c. a dissolution inhibitor and
d. an infrared light-to-heat converting compound.

21. An imageable element comprising,
a. a substrate and
b. a coated and dried layer of the composition of claim 2 on a surface of the substrate.

22. An imageable element comprising,
a. a substrate and
b. a coated and dried layer of the composition of claim 5 on a surface of the substrate.

23. An imageable element comprising,
a. a substrate and
b. a coated and dried layer of the composition of claim 18 on a surface of the substrate.

24. An imageable element comprising,
a. a substrate and
b. a coated and dried layer of the composition of claim 20 on a surface of the substrate.

25. A positive-working lithographic printing precursor comprising a layer of a radiation-sensitive composition on a hydrophilic lithographic printing surface, the composition comprising
a. an acetal resin derived from polyvinyl alcohol by condensation with aldehydes and
b. a developability-enhancing compound.

26. The precursor of claim 25, wherein the composition further comprises an infrared light-to-heat converting compound.

27. The precursor of claim 26, wherein the composition further comprises a dissolution inhibitor.

28. The precursor of claim 25, wherein the developability-enhancing compound is at least one of
a. an alcohol having at least one of an alkyl radical of 12-60 carbon atoms, a fluoroalkyl radical of 4-60 carbon atoms and a fluoroalkylaryl radical of 7-60 carbon atoms;
b. a polyol;
c. a monohydric phenol;
d. a polyhydric phenol;
e. a compound containing thiol functionality;
f. an anionic lithium salt that is one of a carboxylate, thiocarboxylate, sulfate, sulfonate, phosphate, phosphite, nitrate and nitrite;
g. an ester of a phosphorous-containing acid;
h. an amide of a phosphorus containing acid;
i. a polysiloxane;
j. a quaternary ammonium salt having a free hydroxyl group.
k. an azo compound;
l. a compound containing —NH—NH— functionality;
m. a compound containing —NH—N═C [symbol] functionality;
n. a compound containing the structure 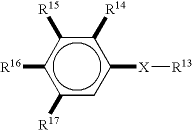
where X is one of —S—, S═O, C═O or CO₂ and where R¹³ can be a C₁ to C₁₂ alkyl, benzyl or structure E, where E is given by 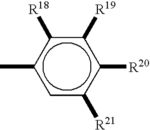
and where R¹⁴, R¹⁵, R¹⁶, R¹⁷, R¹⁸, R¹⁹, R²⁰, R²¹ can be one of H and OH.
o. a substituted aromatic acid;
p. a substituted aromatic ester;
q. a substituted aromatic amide and
r. a compound containing sulfone functionality.

29. The precursor of claim 28, wherein the polyol is dimethicone copolyol.

30. The precursor of claim 28, wherein the polyhydric phenol is at least one of resorcinol, 4-hexylresorcinol, n-dodecylresorcinol and 1-naphthole.

31. The precursor of claim 28, wherein the polyhydric phenol is one of pyrogallol, phloroglucinol, 1,2,4-benzenetriol and their alkyl and fluoroalkyl derivatives.

32. The precursor of claim 28, wherein the anionic lithium salt is one of lithium 3-(1H,1H,2H,2H-fluoroalkyl) propionate and 3-[(1H,1H,2H,2H-fluoroalkyl)thio]propionate, lithium trifluoromethane sulfonate and lithium perfluorooctylethylsulfonate.

33. The precursor of claim 28, wherein the ester of a phosphorus containing acid is one of P(OH)(OR)₂, P(OH)₂(OR), P(OH)₂[O—R—N(CH₂—CH₂—OH)₂], P(OR)₂[O—R—NH(CH₂—CH₂—OH)₂], where R is an alkyl, aryl, alkylaryl, polyethylene oxide, polypropyleneoxide or combination thereof.

34. The precursor of claim 28, wherein the ester of a phosphorus containing acid is a nonylphenol phosphate ester.

35. The precursor of claim 28, wherein the amide of a phosphorus containing acid is one of P(OH)(ONHR)₂, P(OH)₂(ONHR), P(OR)₂[O—NH(CH₂—CH₂—OH)₂], P(OR)[O—NH(CH₂—CH₂—OH)₂]₂, where R is an alkyl, aryl, polyethylene oxide, polypropyleneoxide or combination thereof.

36. The precursor of claim 28, wherein the polysiloxane is R[OSi(OCH₃)₂]ₙ—Si(OCH₃)(OH)₂ where R is an alky, aryl, polyethyleneoxide, polypropyleneoxide group or combination thereof and n=2-1000.

37. A composition according to claim 28, wherein the substituted aromatic acid is at least one of 2-nitrobenzoic acid, 3-Nitrobenzoic acid, 4-Nitrobenzoic acid, 2,4-Dinitrobenzoic acid, 2,4-Dichlorobenzoic acid, 2-Hydroxy-1-napthoic acid and 3-Hydroxy-2-napthoic acid.

38. A composition according to claim 28, wherein the substituted aromatic ester is methyl salicylate, phenyl salicylate, benzyl-4-hydroxybenzoate, Butyl-4-hydroxybenzoate and methyl-4-hydroxy benzoate.

39. A composition according to claim 28, wherein the substituted aromatic amide is 3-nitrobenzamide and (2′-Hydroxyethyl)-2,4-dihydroxybenzamide.

40. A positive-working lithographic printing precursor comprising a layer of a radiation-sensitive composition on a hydrophilic lithographic printing surface, the composition comprising
a. an acetal resin derived from polyvinyl alcohol by condensation with aldehydes and
b. a developability-enhancing compound,
wherein the acetal resin has the structure 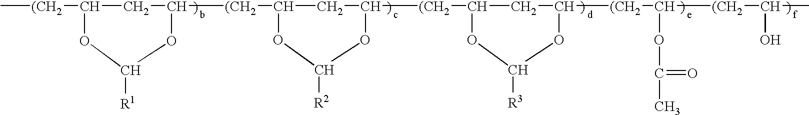
in which R¹ is —CₙH₂ₙ₊₁ where n=1 to 12, and R² is 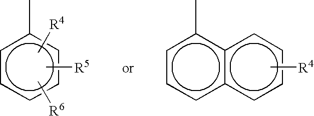
wherein R⁴═—OH;
R⁵═—OH or —OCH₃ or Br— or —O—CH₂—C≡CH and
B⁶═Br— or NO₂
R³═—(CH₂)ₜ—COOH, —C≡CH, or 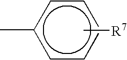
where R⁷═COOH, —(CH₂)ₜ—COOH, —O—(CH₂)ₜ—COOH
and in which t=1 to 4, and where b=5 to 40 mole %, preferably 15 to 35 mole %
c=10 to 60 mole %, preferably 20 to 40 mole %
d=0 to 20 mole %, preferably 0 to 10 mole %
e=2 to 20 mole %, preferably 1 to 10 mole %
and f=5 to 50 mole %, preferably 15 to 40 mole %.

41. The precursor of claim 40, wherein the developability-enhancing compound is at least one of
a. an alcohol having at least one of an alkyl radical of 12-60 carbon atoms, a fluoroalkyl radical of 4-60 carbon atoms and a fluoroalkylaryl radical of 7-60 carbon atoms;
b. a polyol;
c. a monohydric phenol;
d. a polyhydric phenol;
e. a compound containing thiol functionality;
f. an anionic lithium salt that is one of a carboxylate, thiocarboxylate, sulfate, sulfonate, phosphate, phosphite, nitrate and nitrite;
g. an ester of a phosphorous-containing acid;
h. an amide of a phosphorus containing acid;
i. a polysiloxane;
j. a quaternary ammonium salt having a free hydroxyl group.
k. an azo compound;
l. a compound containing —NH—NH— functionality;
m. a compound containing —NH—N═C [symbol] functionality;
n. a compound containing the structure 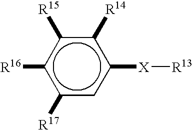
where X is one of —S—, S═O, C═O or CO₂ and where R¹³ can be a C₁ to C₁₂ alkyl, benzyl or structure E, where E is given by 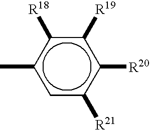
and where R¹⁴, R¹⁵, R¹⁶, R¹⁷, R¹⁸, R¹⁹, R²⁰, R²¹ can be one of H and OH.
o. a substituted aromatic acid;
p. a substituted aromatic ester;
q. a substituted aromatic amide and
r. a compound containing sulfone functionality.

42. The precursor of claim 41, wherein the polyhydric phenol is at least one of resorcinol, 4-hexylresorcinol, n-dodecylresorcinol and 1-naphthole.

43. A positive-working lithographic printing precursor comprising a layer of a radiation-sensitive composition on a hydrophilic lithographic printing surface, the composition comprising:
a. at least one of resorcinol, n-dodecyl resorcinol, 4-hexyl resorcinol and 1-naphthole,
b. an acetal resin formed by the condensation of polyvinyl alcohol with aldehydes,
c. a dissolution inhibitor and
d. an infrared light-to-heat converting compound.

44. A method for making a positive-working lithographic printing precursor, the method comprising the steps of coating a hydrophilic lithographic printing surface with a layer of a radiation-sensitive composition and drying the layer, wherein the composition comprises
a. an acetal resin derived from polyvinyl alcohol by condensation with aldehydes and
b. a developability-enhancing compound.

45. The method of claim 44, wherein the composition further comprises an infrared light-to-heat converting compound.

46. The method of claim 45, wherein the composition further comprises a dissolution inhibitor.

47. The method of claim 45, wherein the developability-enhancing compound is at least one of
a. an alcohol having at least one of an alkyl radical of 12-60 carbon atoms, a fluoroalkyl radical of 4-60 carbon atoms and a fluoroalkylaryl radical of 7-60 carbon atoms;
b. a polyol;
c. a monohydric phenol;
d. a polyhydric phenol;
e. a compound containing thiol functionality;
f. an anionic lithium salt that is one of a carboxylate, thiocarboxylate, sulfate, sulfonate, phosphate, phosphite, nitrate and nitrite;
g. an ester of a phosphorous-containing acid;
h. an amide of a phosphorus containing acid;
i. a polysiloxane;
j. a quaternary ammonium salt having a free hydroxyl group.
k. an azo compound;
l. a compound containing —NH—NH— functionality;
m. a compound containing —NH—N═C [symbol] functionality;
n. a compound containing the structure 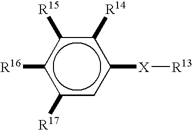
where X is one of —S—, S═O, C═O or CO₂ and where R¹³ can be a C₁ to C₁₂ alkyl, benzyl or structure E, where E is given by 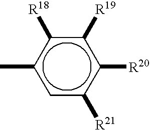
and where R¹⁴R¹⁵, R¹⁶, R¹⁷, R¹⁸, R¹⁹, R²⁰, R²¹ can be one of H and OH.
o. a substituted aromatic acid;
p. a substituted aromatic ester;
q. a substituted aromatic amide and
r. a compound containing sulfone functionality.

48. The method of claim 47, wherein the polyol is dimethicone copolyol.

49. The method of claim 47, wherein the polyhydric phenol is at least one of resorcinol, 4-hexylresorcinol, n-dodecylresorcinol and 1-naphthole.

50. The method of claim 47, wherein the polyhydric phenol is one of pyrogallol, phloroglucinol, 1,2,4-benzenetriol and their alkyl and fluoroalkyl derivatives.

51. The method of claim 47, wherein the anionic lithium salt is one of lithium 3-(1H,1H,2H,2H-fluoroalkyl) propionate and 3-[(1H,1H,2H,2H-fluoroalkyl)thio]propionate, lithium trifluoromethane sulfonate and lithium perfluorooctylethylsulfonate.

52. The method of claim 47, wherein the ester of a phosphorus containing acid is one of P(OH)(OR)₂, P(OH)₂(OR), P(OH)₂[O—R—N(CH₂—CH₂—OH)₂], P(OR)₂[O—R—NH(CH₂—CH₂—OH)₂], where R is an alkyl, aryl, alkylaryl, polyethylene oxide, polypropyleneoxide or combination thereof.

53. The method of claim 47, wherein the ester of a phosphorus containing acid is a nonylphenol phosphate ester.

54. The method of claim 47, wherein the amide of a phosphorus containing acid is one of P(OH)(ONHR)₂, P(OH)₂(ONHR), P(OR)₂[O—NH(CH₂—CH₂—OH)₂], P(OR)[O—NH(CH₂—CH₂—OH)₂]₂, where R is an alkyl, aryl, polyethylene oxide, polypropyleneoxide or combination thereof.

55. The method of claim 47, wherein the polysiloxane is R[OSi(OCH₃)₂]ₙ—Si(OCH₃)(OH)₂ where R is an alky, aryl, polyethyleneoxide, polypropyleneoxide group or combination thereof and n=2-1000.

56. A composition according to claim 47, wherein the substituted aromatic acid is at least one of 2-nitrobenzoic acid, 3-Nitrobenzoic acid, 4-Nitrobenzoic acid, 2,4-Dinitrobenzoic acid, 2,4-Dichlorobenzoic acid, 2-Hydroxy-1-napthoic acid and 3-Hydroxy-2-napthoic acid.

57. A composition according to claim 47, wherein the substituted aromatic ester is methyl salicylate, phenyl salicylate, benzyl-4-hydroxybenzoate, Butyl-4-hydroxybenzoate and methyl-4-hydroxy benzoate.

58. A composition according to claim 47, wherein the substituted aromatic amide is 3-nitrobenzamide and (2′-Hydroxyethyl)-2,4-dihydroxybenzamide.

59. A method for making a positive-working lithographic printing precursor, the method comprising the steps of coating a hydrophilic lithographic printing surface with a layer of a radiation-sensitive composition and drying the layer, wherein the composition comprises
a. an acetal resin derived from polyvinyl alcohol by condensation with aldehydes and
b. a developability-enhancing compound,
wherein the acetal resin has the structure 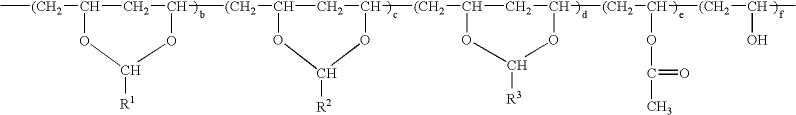
in which R¹ is —CₙH₂ₙ₊₁ where n=1 to 12, and R² is 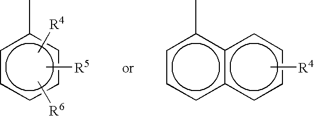
wherein R⁴═—OH;
R⁵═—OH or —OCH₃ or Br— or —O—CH₂—C≡CH and
B⁶═Br— or NO₂
R³═—(CH₂)ₜ—COOH, —C≡CH, or 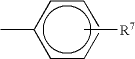
where R⁷═COOH, —(CH₂)ₜ—COOH, —O—(CH₂)ₜ—COOH
and in which t=1 to 4, and where b=5 to 40 mole %, preferably 15 to 35 mole %
c=10 to 60 mole %, preferably 20 to 40 mole %
d=0 to 20 mole %, preferably 0 to 10 mole %
e=2 to 20 mole %, preferably 1 to 10 mole %
and f=5 to 50 mole %, preferably 15 to 40 mole %.

60. The method of claim 59, wherein the developability-enhancing compound is at least one of
a. an alcohol having at least one of an alkyl radical of 12-60 carbon atoms, a fluoroalkyl radical of 4-60 carbon atoms and a fluoroalkylaryl radical of 7-60 carbon atoms;
b. a polyol;
c. a monohydric phenol;
d. a polyhydric phenol;
e. a compound containing thiol functionality;
f. an anionic lithium salt that is one of a carboxylate, thiocarboxylate, sulfate, sulfonate, phosphate, phosphite, nitrate and nitrite;
g. an ester of a phosphorous-containing acid;
h. an amide of a phosphorus containing acid;
i. a polysiloxane;
j. a quaternary ammonium salt having a free hydroxyl group.
k. an azo compound;
l. a compound containing —NH—NH— functionality;
m. a compound containing —NH—N═C [symbol] functionality;
n. a compound containing the structure 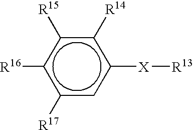
where X is one of —S—, S═O , C═O or CO₂ and where R¹³ can be a C₁ to C₁₂ alkyl, benzyl or structure E, where E is given by 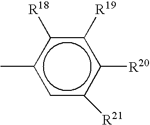
and where R¹⁴R¹⁵, R¹⁶, R¹⁷, R¹⁸, R¹⁹, R²⁰, R²¹ can be one of H and OH.
o. a substituted aromatic acid;
p. a substituted aromatic ester;
q. a substituted aromatic amide and
r. a compound containing sulfone functionality.

61. The method of claim 60, wherein the polyhydric phenol is at least one of resorcinol, 4-hexylresorcinol, n-dodecylresorcinol and 1-naphthole.

62. A method for making a positive-working lithographic printing precursor, the method comprising the steps of coating a hydrophilic lithographic printing surface with a layer of a radiation-sensitive composition and drying the layer, wherein the composition comprises
a. at least one of resorcinol, n-dodecyl resorcinol, 4-hexyl resorcinol and 1-naphthole,
b. an acetal resin formed by the condensation of polyvinyl alcohol with aldehydes,
c. a dissolution inhibitor and
d. an infrared light-to-heat converting compound.

63. A method for making a lithographic printing master, the method comprising the steps of
a. providing a lithographic printing precursor comprising a layer of a radiation-sensitive composition on a hydrophilic lithographic printing surface, the composition comprising
i. an acetal resin derived from polyvinyl alcohol by condensation with aldehydes and
ii. a developability-enhancing compound,
b. imagewise irradiating areas of the layer with imaging radiation to render the layer more soluble in an aqueous alkaline solution in the areas irradiated.

64. The method of claim 63, wherein the composition further comprises an infrared light-to-heat converting compound.

65. The method of claim 64, wherein the composition further comprises a dissolution inhibitor.

66. The method of claim 64, wherein the developability-enhancing compound is at least one of
a. an alcohol having at least one of an alkyl radical of 12-60 carbon atoms, a fluoroalkyl radical of 4-60 carbon atoms and a fluoroalkylaryl radical of 7-60 carbon atoms;
b. a polyol;
c. a monohydric phenol;
d. a polyhydric phenol;
e. a compound containing thiol functionality;
f. an anionic lithium salt that is one of a carboxylate, thiocarboxylate, sulfate, sulfonate, phosphate, phosphite, nitrate and nitrite;
g. an ester of a phosphorous-containing acid;
h. an amide of a phosphorus containing acid;
i. a polysiloxane;
j. a quaternary ammonium salt having a free hydroxyl group.
k. an azo compound;
l. a compound containing —NH—NH— functionality;
m. a compound containing —NH—N═C [symbol] functionality;
n. a compound containing the structure 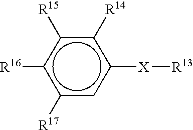
where X is one of —S—, S═O , C═O or CO₂ and where R¹³ can be a C₁ to C₁₂ alkyl, benzyl or structure E, where E is given by 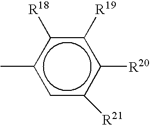
and where R¹⁴, R¹⁵, R¹⁶, R¹⁷, R¹⁸, R¹⁹, R²⁰, R²¹ can be one of H and OH.
o. a substituted aromatic acid;
p. a substituted aromatic ester;
q. a substituted aromatic amide and
r. a compound containing sulfone functionality.

67. The precursor of claim 66, wherein the polyhydric phenol is at least one of resorcinol, 4-hexylresorcinol, n-dodecylresorcinol and 1-naphthole.

68. A method for making a lithographic printing master, the method comprising the steps of
a. providing a lithographic printing precursor comprising a layer of a radiation-sensitive composition on a hydrophilic lithographic printing surface, the composition comprising
i. an acetal resin formed by the condensation of polyvinyl alcohol with aldehydes,
ii. at least one of resorcinol, n-dodecyl resorcinol, 4-hexyl resorcinol and 1-naphthole,
iii. a dissolution inhibitor and
iv. an infrared light-to-heat converting compound.
b. imagewise irradiating areas of the layer with imaging radiation to render the layer more soluble in an aqueous alkaline solution in the areas irradiated.
